(19) United States
(12) Patent Application Publication
(10) Pub. No.: US 2016/0218991 A1
(43) Pub. Date: Jul. 28, 2016

(54) PROVISIONING OF ISOLATED PATH FROM COMPUTER TO CO-LOCATED STORAGE

(71) Applicant: NetApp, Inc., Sunnyvale, CA (US)

(72) Inventors: Dekel Sharabi, Tel-Aviv (IL); Michael Yakobi, Tel-Aviv (IL); Hili Erel-Gichon, Lapid (IL); Tzachi Strugo, Zoran (IL); John Keith Fullbright, Evans, GA (US); Mark Duane Beaupre, Los Gatos, CA (US)

(21) Appl. No.: 14/604,440

(22) Filed: Jan. 23, 2015

(51) Int. Cl. H04L 12/911; G06F 9/455

(52) U.S. Cl. CPC H04L 47/70; G06F 9/45533

(57) ABSTRACT

Systems and methods provision isolated paths from virtual private clouds to corresponding storage virtual machines. In response to a determination that resources for a first tenant of the virtual private cloud are to be provisioned, a subnet for the virtual private cloud is created, where the subnet does not overlap with any other subnet on a network associated with the virtual private cloud. A first VLAN is created on a gateway communicably coupled to the storage server. A first storage virtual machine (SVM) associated with the tenant is created. One or more storage volumes of one or more storage devices are associated with the SVM, where the one or more storage volumes are not allocated to any other SVM.

### BACKGROUND

Embodiments of the inventive subject matter generally relate to the field of distributed storage systems, and, more particularly, to provisioning an isolated communications path from a compute node to remote storage.

Various large enterprises (e.g., businesses) may need to store large amounts of data (e.g., financial records, human resource information, research and development data, etc.) and may need to run data analysis applications on their data. In some cases, businesses turn to cloud computing and storage environments to store data and to provide computing resources for data analysis applications. However, cloud environments typically provide a limited set of features and performance characteristics in the storage solutions that can be provided to a customer.

### SUMMARY

A resource manager can provision physical storage resources on a storage server and network resources that can be integrated with conventional cloud storage and computing resources. The resource manager can provision VLANs (Virtual Local Area Networks) and subnets through gateways. The resource manager can configure the gateways to isolate the network traffic of one customer from the network traffic other customers. Further, the resource manager can provision storage virtual machines on the storage server that isolate one customer's storage resources from another customer's storage resources on the storage server. Thus a path from a customer's storage resources on a storage server to the customer's VPC in a cloud environment is isolated from other customers' paths from their respective storage resources on the storage server to their respective VPCs.

### BRIEF DESCRIPTION OF THE DRAWINGS

The present embodiments may be better understood by referencing the accompanying drawings.

FIG. 1 depicts a system diagram of a distributed storage system according to aspects of the disclosure.

FIGS. 2 and 3 provide further details of the distributed storage system, including providing an isolated path from a compute node to remote storage according to aspects of the disclosure.

FIG. 4 illustrates a software operating environment for a storage controller and a storage virtual machine.

FIG. 5 is a flow chart illustrating a method for provisioning an isolated path from a compute node to remote storage according to aspects of the disclosure.

FIG. 6 depicts a hardware configuration of a storage server according to aspects of the disclosure.

### DESCRIPTION OF EMBODIMENT(S)

The description that follows includes example systems, methods, techniques, instruction sequences and computer program products that embody techniques of the inventive subject matter. However, it is understood that the described features and aspects may be practiced without these specific details. For instance, although examples refer to a compute node as part of a cloud based architecture, the compute node can be located on any computer in a distributed network of computers. In other instances, well-known instruction instances, protocols, structures and techniques have not been shown in detail in order not to obfuscate the description.

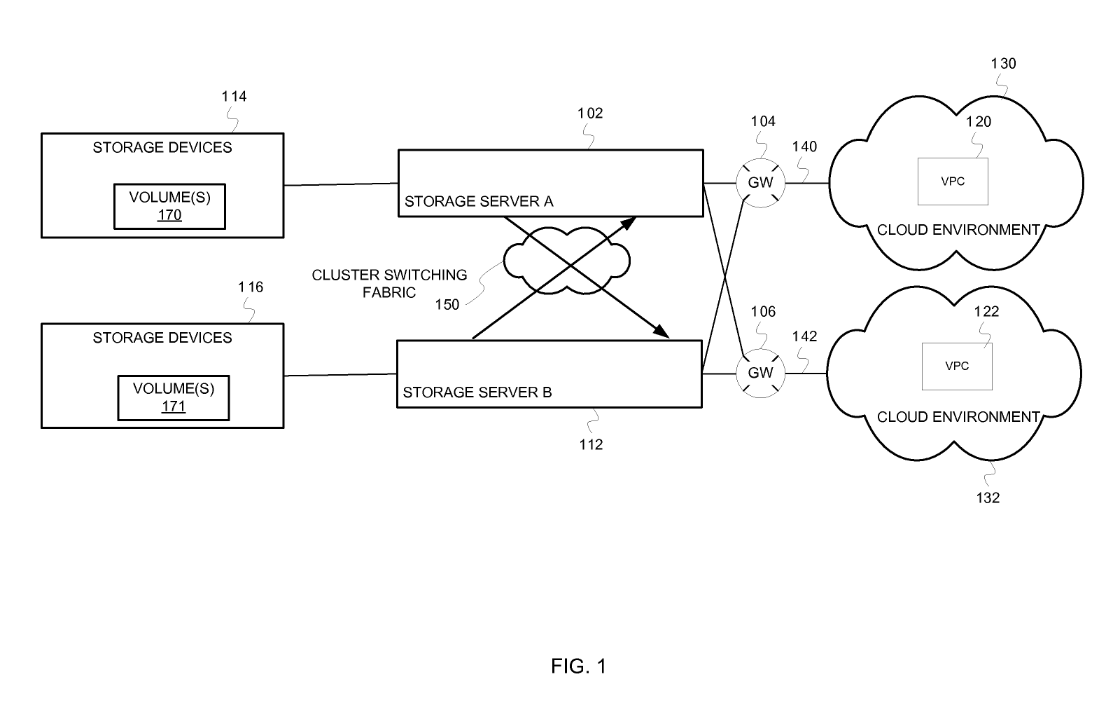

FIG. 1 depicts a system diagram of a distributed storage system according to aspects of the disclosure. FIG. 1 depicts a system that includes a cluster 100 of storage servers. In this example, the cluster 100 includes a storage server 102 and a storage server 112 interconnected through a cluster switching fabric 150. The storage servers 102 and 112 include various functional components that cooperate to provide a distributed storage system architecture of the cluster.

The storage server 102 is communicatively coupled to store and retrieve data into and from a data storage device 114. The storage server 112 is communicatively coupled to store and retrieve data into and from a data storage device 116.

According to some features, data storage devices 114 and 116 include volumes, which are components of storage of information in disk drives, disk arrays, and/or other data stores (e.g., flash memory) as a file-system for data, for example. In this example, the data storage device 114 includes volume(s) 170. The data storage device 116 includes volume(s) 171. According to some features, volumes can span a portion of a data store, a collection of data stores, or portions of data stores, for example, and typically define an overall logical arrangement of file storage on data store space in the distributed file system. According to some features, a volume can comprise stored data containers (e.g., files) that reside in a hierarchical directory structure within the volume. Volumes are typically configured in formats that may be associated with particular file systems, and respective volume formats typically comprise features that provide functionality to the volumes, such as providing an ability for volumes to form clusters. For example, a first file system may utilize a first format for its volumes, and a second file system may utilize a second format for its volumes.

The volumes can include a collection of physical storage disks cooperating to define an overall logical arrangement of volume block number (VBN) space on the volume(s). Each logical volume is generally, although not necessarily, associated with its own file system. The disks within a logical volume/file system are typically organized as one or more groups, wherein each group may be operated as a Redundant Array of Independent (or Inexpensive) Disks (RAID). Most RAID configurations, such as a RAID-4 level configuration, enhance the reliability/integrity of data storage through the redundant writing of data “stripes” across a given number of physical disks in the RAID group, and the appropriate storing of parity information with respect to the striped data. An illustrative example of a RAID configuration is a RAID-4 level configuration, although it should be understood that other types and levels of RAID configurations may be used in accordance with some features.

The storage servers 102 and 112 can be communicatively coupled to compute nodes over a network 140 and a network 142. In some embodiments, the compute nodes may be part of a Virtual Private Cloud (VPC) provided in a cloud computing and storage environment. The cloud environment can provide a virtual private cloud (VPC) to clients. In the example illustrated in FIG. 1, VPC 120 and VPC 122 are provided in the cloud environment. In some aspects, the cloud environment may be the Amazon Web Services environment provided by Amazon.com, Inc. of Seattle, Wash. However, other cloud environments may be used and are within the scope of the disclosure. In the example shown in FIG. 1, two cloud environments are shown, cloud environment 130 and 132. As an example, cloud environment 130 may comprise a first region within Amazon Web Services and cloud environment 132 may comprise a different region within Amazon Web Services.

Cloud environments coupled to cluster 100 may be coupled to storage servers 102 and 112 through networks 140 and 142 using gateways 104 and 106 respectively. In some aspects, each storage server in a cluster is communicably coupled to the gateways in the cluster so that each storage server in the cluster can access each cloud environment in the cluster. Thus, as shown in FIG. 1, storage servers 102 and 112 are each coupled to both of gateways 104 and 106.

According to some features, storage server 112 can serve as a backup to storage server 102. Further, VPC 122 can serve as a backup to VPC 120. Similarly, a node in one cluster can be defined as a backup to a node in a different cluster, referred to as a primary node. Data stored in the data storage device 114 can be duplicated in the data storage device 116. Accordingly, if the storage server 102 were to fail or become otherwise nonoperational (e.g., for maintenance), the storage server 112 can become active to process data requests for data stored in the data storage device 114. The redundant gateways, networks and cloud environments provide a cluster 100 where there is no single point of failure with respect to the storage and communication capabilities of the cluster 100.

In some aspects, the cluster resources of storage server A 102 and storage server B 112 are co-located with the hardware resources of a provider of cloud environment 130. In other words, the hardware resources of storage serve A 102, storage server B 112 and the server and storage resources associated with cloud environments 130 and 132 can be located in the same datacenter, even though different entities may own and manage the storage servers 102 and 112 and the cloud resources. As an example, the storage servers 102 and 112 may be part of “direct connect” configuration with resources in one or more of Amazon.com's AWS regions. In some aspects, cloud environment 130 may be provided by one availability zone in an AWS region, while cloud environment 132 may be provided by a different availability zone in the AWS region.

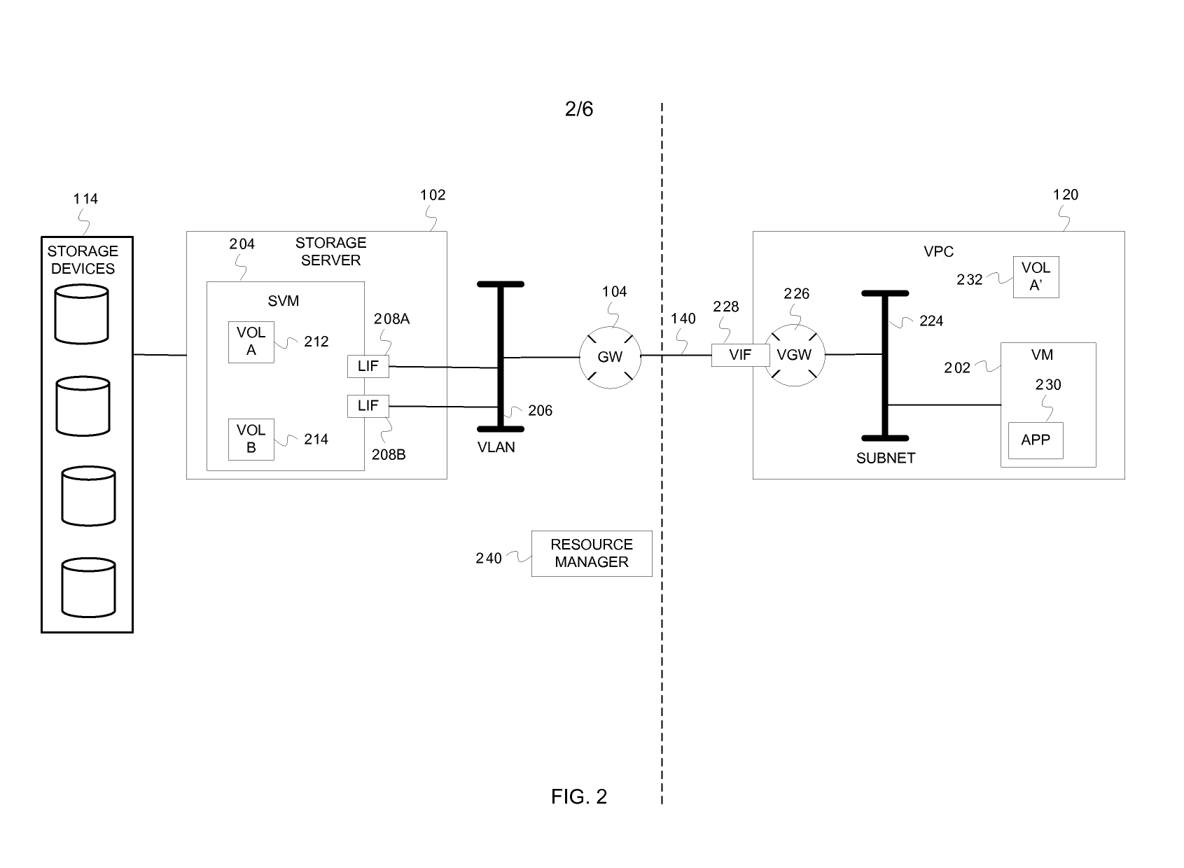

FIG. 2 provides further details of the distributed storage system, including providing an isolated path from a compute node to remote storage according to aspects of the disclosure. In some aspects, storage server 102 includes a storage virtual machine (SVM) 204. SVM 204 provides virtualized data storage that can be shared by multiple clients and can be configured to manage particular volumes on data storage device 114. In the example shown in FIG. 2, SVM 204 is configured to manage two of the volumes of storage device 114, volume A 212 and volume B 214. SVM 204 can provide one or more logical interfaces that are mapped to the physical network interfaces provided on storage server 102. Logical interfaces 208A and 208B communicate with clients of the SVM 204. A logical interface can have associated characteristics, such as a role, a home port, a home node, a routing group, a list of ports to fail over to, and a firewall policy. A LIF role determines the kind of traffic that is supported over the interface, along with the failover rules that apply, the firewall restrictions that are in place, the security, the load balancing, and the routing behavior for each LIF. In the example shown in FIG. 2, SVM 204 provides two logical interfaces, logical interfaces 208A and 208B. Logical interfaces 208A and 208B can receive commands and data from clients that are interpreted by SVM 204 to cause the SVM 204 to read data, write data and perform maintenance operations on volume A 212 and/or volume B 214.

Gateway 104 can be configured create a Virtual Local Area Network (VLAN) 206 on a network of cluster 100. Logical interfaces 208A and 208B can be communicably coupled to the VLAN 206. Thus according to some features, SVM 204 securely isolates the shared virtualized data storage and network resources managed by SVM 204, and appears as a single dedicated server to its clients.

VPC 120 can be created, managed and updated by a cloud environment 130 and can create both virtual machines (VMs) that execute applications, and virtual machine disks (VMDKs) that provide storage for the VPC. In some aspects, a subnet 224 is assigned to VPC 120. The subnet can be managed by a virtual gateway 226. In addition, virtual gateway 226 can provide a virtual interface 228 that maps to a physical interface of a physical gateway that communicably couples the cloud provider (e.g., Amazon.com AWS) to network 140. In some aspects, virtual interface 228 is coupled to gateway 104 over a network connection that implements a BGP (Border Gateway Protocol).

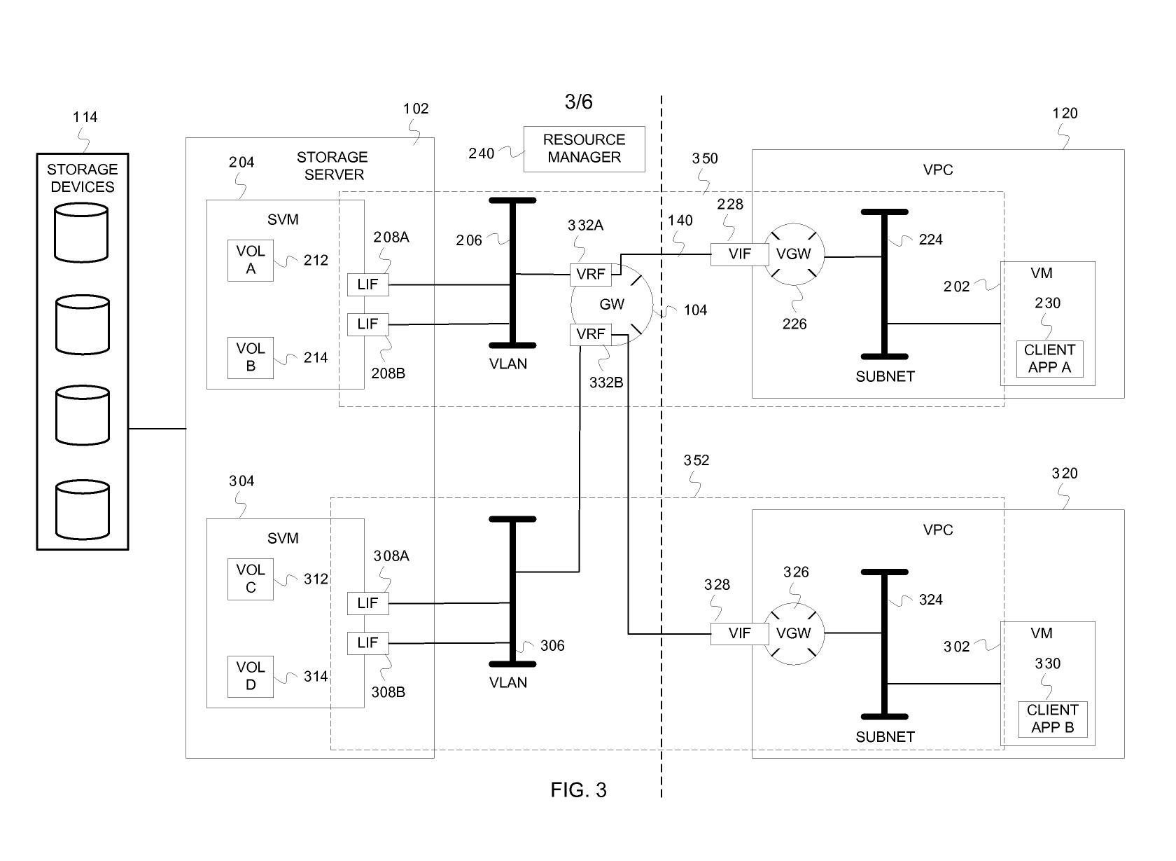

The distributed storage system can include a resource manager 240. Resource manager 240 can manage provisioning and allocation of resources of storage server 102 and VPC 120 to clients. For example, resource manager 240 can create SVMs, allocate volumes to SVMs, create and allocate physical and virtual network resources for coupling SVM 102 to VPC 120, and other management and provisioning activities for the distributed storage system. In some aspects, resource manager 240 can be part of the OnCommand Cloud Manager from NetApp Inc. of Sunnyvale, Calif. Further details on the operations performed by resource manager 240 are provided below with reference to FIGS. 3-5.

In the example illustrated in FIG. 2, VPC 120 includes a virtual machine (VM) 202 that is configured to execute an application 230. Application 230 can be any type of application that makes use of storage provided by SVM 204. In some aspects, SVM 204 provides storage resources (e.g., volume A 212 and volume B 214) that can be accessed and used by application 230. For example, application 230 can be a data analysis application that provides data mining or other analysis of data stored on volume A 212. Other applications (either cloud resident or local clients of storage server 102) can generate the data on volume A 212. In order to prevent the data analysis application from overtaxing the resources of storage server 102, application 230 can make a copy of volume A 212, e.g., volume A′ 232, using storage resources on VPC 120. The analysis application 230 can then operate on its own local copy of the data.

FIG. 3 provides further details of the distributed storage system, including a logical communication layer in an isolated path from a compute node to remote storage according to aspects of the disclosure. FIG. 3 includes the elements of FIG. 2 (e.g., SVM 204, VPC 120, gateway 104, network 140, resource manager 240 etc.). For the purposes of the example illustrated in FIG. 3, assume that two different customers desire to use resources managed by storage server 204. Further assume that customer A's environment has been provisioned with the previously described SVM 204, VPC 120, and their respective components (e.g., volume A 212, volume B 214, VM 230, virtual gateway 226 and virtual interface 228). A different second customer can also use the resources of storage server 102. Different customers may be referred to as “tenants” of the storage server. Different tenants can be provisioned with separate SVMs and VPCs. For example, a SVM 304 and VPC 320 can be provisioned for the second customer of the storage resources provided by storage server 102 and the compute resources provided by cloud environment 130. In the example illustrated in FIG. 3, customer B has been provisioned with storage on volume C 312 and volume D 314 that are managed by SVM 304. In addition, a separate VLAN 306 is provisioned on gateway 104 for communicably coupling SVM 304 to VPC 320 via gateway 104 and network 140.

According to some features, the SVMs created on a storage server can be communicably coupled to a VRF (Virtual Router/Forwarder) that can be configured on gateway 104. In the example illustrated in FIG. 3, SVM 204 is configured to be communicably coupled to VRF 332A and SVM 304 is configured to be communicably coupled to VRF 332B. A VRF (e.g., VRF 332A, 332B) allows multiple instances of a routing table to co-exist within the same gateway 104 at the same time. Each VRF utilizes an instance of a routing table to route or forward network traffic. The separate routing tables for each VRF allow network paths to be segmented within a single network device. Because the routing instances are independent, the same or overlapping IP addresses can be used without conflicting with each other. For example, tenants A and B can connect their respective VPC subnets to a shared gateway. Both VPCs can use the same IP CIDR (e.g., 10.0.1.0/28). VRFs enable connecting each VPC to a dedicated SVM in the shared cluster without causing routing conflicts.

VPC 320 is provisioned with a virtual gateway 326 and virtual interface 328 that also manage a subnet 324. In addition, a VM 302 is provisioned in VPC 320. Customer B can execute its own applications (e.g., application 332) on VM 302.

As can be seen from the above, each tenant of the resources of the storage server are isolated from one another using separate SVMs, VLANs, virtual gateways, virtual interfaces, and virtual private cloud resources. The SVMs, VLANs, network resources and storage resources used by one tenant are isolated from other tenants of the storage server 102. In other words, the storage resources and network resources used by one tenant are logically separated from the resources used by a different tenant. In the example illustrated in FIG. 3, a logical layer 350 includes components provisioned for Customer A, while a logical layer 352 includes the components provisioned for Customer B. Each logical layer is isolated from the other logical layers provisioned in the storage server 102 and the cloud environment 130.

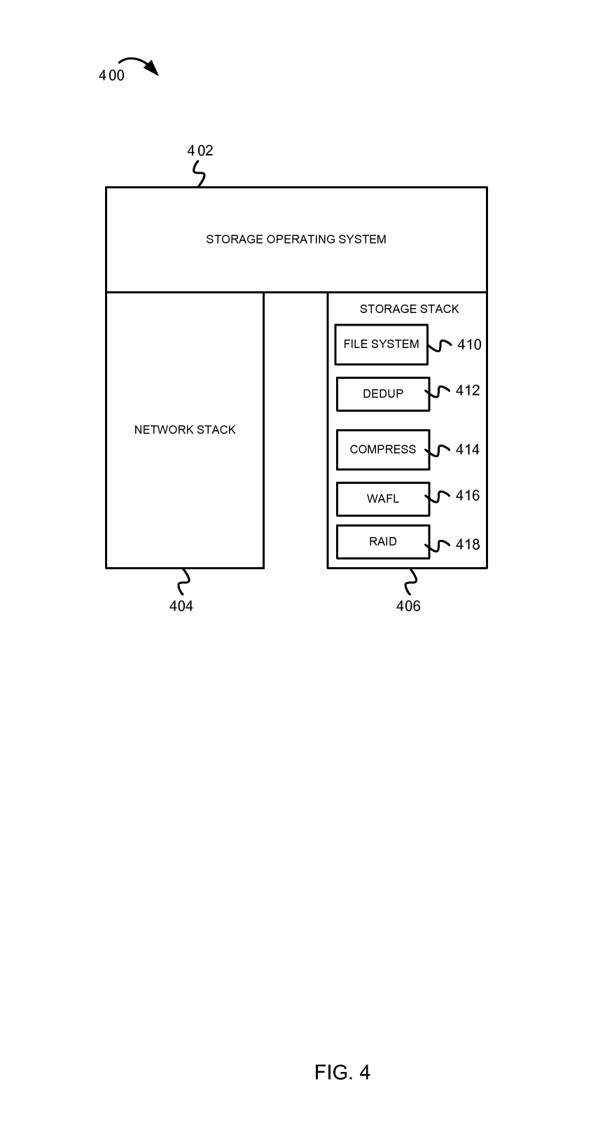

FIG. 4 depicts a software environment of a storage virtual machine according to aspects of the disclosure. In particular, FIG. 4 illustrates a software operating environment 400 for the storage controller and SVM disclosed herein. In some aspects of the disclosure, the software operating environment 400 includes a storage operating system 402, a network stack 404, and a storage stack 406. Storage operating system 402 controls the operations of a storage server 102. For example, storage operating system 402 can direct the flow of data through the various interfaces and stacks provided by the hardware and software of a storage server/controller. As an example, storage operating system 402 can be a version of the Clustered Data ONTAP® storage operating system included in storage controller products available from NETAPP®, Inc. (“NETAPP”) of Sunnyvale, Calif.

Network stack 404 provides an interface for communication via a network. For example, network stack 404 can be a TCP/IP, UDP/IP protocol stack. Other network stacks may be used and are within the scope of the inventive subject matter.

Storage stack 406 provides an interface to and from a storage unit, such as a storage unit within storage devices 114 (FIG. 1). Storage stack may include various drivers and software components used to provide both basic communication capability with a storage unit and provide various value-added components such as a file system layer 410, a data deduplication layer 412, a data compression layer 414, a write anywhere file layout (WAFL) layer 416, a RAID layer 418, and other enhanced storage functions. The components may be arranged as layers in the storage stack 406 or they may be independent of a layered architecture.

File systems layer 410 can be a file system protocol layer that provides multi-protocol file access. Examples of such file system protocols include the Direct Access File System (DAFS) protocol, the Network File System (NFS) protocol, and the CIFS protocol.

Data deduplication layer 412 can be used to provide for more efficient data storage by eliminating multiple instances of the same data stored on storage units. Data blocks that are duplicated between files are rearranged within the storage units such that one copy of the data occupies physical storage. References to the single copy can be inserted into the file system structure such that all files or containers that contain the data refer to the same instance of the data.

Data compression layer 414 provides data compression services for the storage controller. File data may be compressed according to policies established for the storage controller using any lossless data compression technique.

WAFL layer 416 stores data in an on-disk format representation that is block-based using, e.g., 4 kilobyte (KB) blocks and using a data structure such as index nodes (“inodes”) to identify files and file attributes (such as creation time, access permissions, size and block location). In WAFL architectures, modified data for a file may be written to any available location, as contrasted to write-in-place architectures in which modified data is written to the original location of the data, thereby overwriting the previous data.

RAID (Redundant Array of Independent Disks) layer 418 can be used to distribute file data across multiple storage units to provide data redundancy, error prevention and correction, and increased storage performance. Various RAID architectures can be used as indicated by a RAID level.

The above-described features provided by an SVM can be used to extend the features that can be provided to customers of a VPC service. For example, VPCs typically provide a single file system. Further, VCPs typically do not provide data deduplication features. Such features can be provided to VPC customers using the systems and methods described herein.

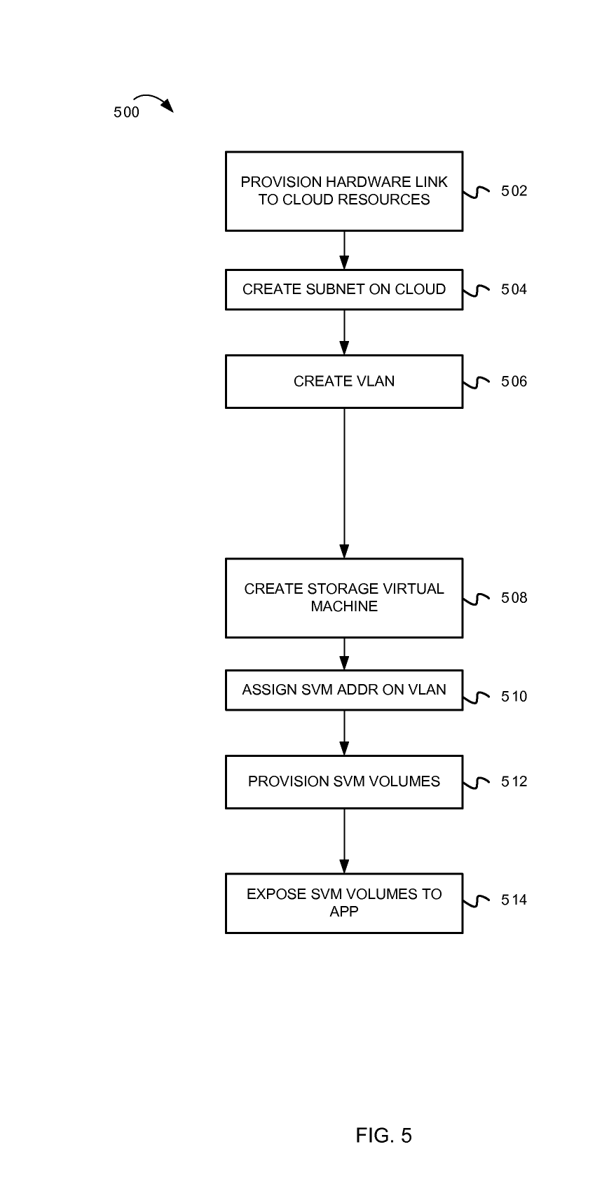

FIG. 5 is a flow chart 500 illustrating a method for provisioning an isolated path from a compute node to remote storage according to aspects of the disclosure. The method may be performed when a new tenant is to be added to a storage server.

At block 502, the cloud resources for a cloud environment are identified, and if necessary allocated to the tenant. For example, a VPC may be created, and resources for the VPC (storage, compute resources) may be allocated and user credentials may be generated. Alternatively, if the tenant already has a VPC, the existing user credentials may be used.

At block 504 a subnet is created on the VPC. The network addresses on the subnet can be managed by the tenant. The subnet is allocated such that only network traffic associated with the tenant's resources is allowed to pass on the subnet. In other words, the subnet address range assigned to the tenant does not overlap with any other subnets on the cloud network.

At block 506 resource manager 240 creates a VLAN on a gateway communicably coupled to a storage server. The VLAN is allocated to the tenant such that only network traffic associated with the tenant's resources is allowed to pass on the VLAN. In other words, the tenant is assigned a VLAN that is unique on the storage server to the tenant.

At block 508, resource manager 240 provisions an SVM for the tenant on the storage server. The SVM may be configured using an administrative interface of the storage server.

At block 510, resource manager 240 assigns addresses on the VLAN to one or more logical network interfaces on the storage server.

At block 512 the resource manager 240 configures an SVM to manage one or more volumes of a storage device. The volumes to be managed by the SVM can be assigned using the administrative interface of the storage server hosting the SVM.

At block 514, resource manager 240 exposes the volumes configured for the SVM to the VPC.

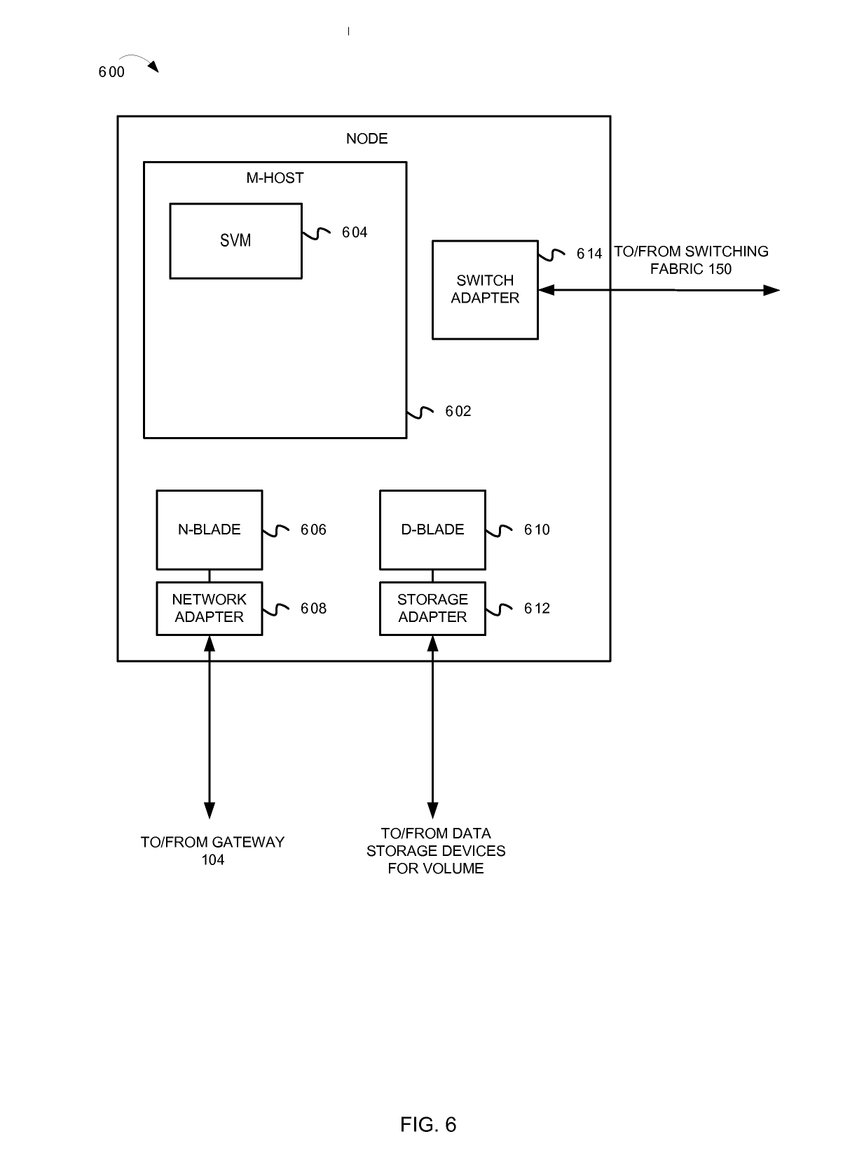

FIG. 6 is a block diagram depicting a hardware configuration of a storage server according to aspects of the disclosure. In particular, FIG. 6 depicts a storage server 600 which can be representative of either or both of storage servers 102 or 112 of FIG. 1. The storage server 600 includes a network adapter 608, a cluster access adapter 614, a storage adapter 612, an N-blade 606, a D-blade 610, and a M-host 602.

The N-blade 606, the D-blade 610, and the M-host 602 can be hardware, software, firmware, or a combination thereof. For example, the N-blade 606, the D-blade 610, and the M-host 602 can be software executing on a processor of storage server 600. Alternatively, the N-blade 606, the D-blade 610, and the M-host 602 can each be independent hardware units within storage server 600, with each having their own respective processor or processors. The N-blade 606 includes functionality that enables the storage server 600 to connect to clients over a network. The D-blade 610 includes functionality to connect to one or more storage devices. It should be noted that while there is shown an equal number of N and D-blades in the illustrative cluster, there may be differing numbers of N and/or D-blades in accordance with some features. The M-host 602 can include functionality for managing the storage server 600.

Each storage server 600 can be embodied as a single or dual processor storage system executing a storage operating system that implements a high-level module, such as a file system, to logically organize the information as a hierarchical structure of named directories, files and special types of files called virtual disks (or generally “objects” or “data containers”) on the disks. One or more processors can execute the functions of the N-blade 606, while another processor(s) can execute the functions of the D-blade 610.

The network adapter 608 includes a number of ports adapted to couple the storage server 600 to one or more VPCs (e.g., VPCs 130, 132 (FIG. 1)) over point-to-point links, wide area networks, virtual private networks implemented over a public network (Internet) or a shared local area network. The network adapter 608 thus may include the mechanical, electrical and signaling circuitry needed to connect the storage server 600 to the network. Illustratively, the network may be embodied as an Ethernet network or a Fibre Channel (FC) network. Each client may communicate with the storage server 600 by exchanging discrete frames or packets of data according to pre-defined protocols, such as TCP/IP.

The storage adapter 612 can cooperate with a storage operating system executing on the storage server 600 or a SVM 604 to access information requested by the clients. The information may be stored on any type of attached array of writable storage device media such as optical, magnetic tape, magnetic disks, solid state drives, bubble memory, electronic random access memory, micro-electro mechanical and any other similar media adapted to store information, including data and parity information. The storage adapter 612 can include a number of ports having input/output (I/O) interface circuitry that couples to the disks over an I/O interconnect arrangement, such as a conventional high-performance, FC link topology. While FIG. 6 shows the SVM 604 as residing in the M-host 602, in alternative aspects, the replication engine may located in other modules.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the inventive subject matter is not limited to them. In general, techniques for providing an isolated path from remote storage resources to compute resources as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for provisioning resources of a storage server for a plurality of tenants, the method comprising:
in response to determining that resources for a first tenant are to be provisioned,
creating a subnet for a virtual private cloud, the subnet not overlapping with any other subnet on a network associated with the virtual private cloud,
creating a first VLAN on a gateway communicably coupled to the storage server,
creating a first storage virtual machine (SVM) associated with the tenant, and
associating one or more storage volumes of one or more storage devices with the SVM, wherein the one or more storage volumes are not allocated to any other SVM.

2. The method of claim 1, further comprising configuring a first routing table for the gateway, wherein the first routing table routes network traffic to the first SVM through the first VLAN and wherein a second routing table configured on the gateway routes network traffic to a second SVM through a second VLAN on the gateway.

3. The method of claim 2, further comprising creating a first virtual router/forwarder on the gateway in response to determining that resources for the first tenant are to be provisioned and configuring the first virtual router/forwarder to use the first routing table to route network traffic for the first SVM through the first VLAN.

4. The method of claim 1, wherein the first SVM provides a file system format that is not available on the virtual private cloud.

5. The method of claim 1, further comprising configuring a logical interface on the first SVM, the logical interface mapped to a physical network port of the storage server, the logical interface having characteristics including one or more failover rules.

6. The method of claim 1, further comprising configuring a network connection between the gateway and a virtual gateway of the virtual private cloud.

7. The method of claim 6, wherein configuring the network connection includes configuring the network connection to utilize a Border Gateway Protocol.

8. A non-transitory machine readable medium having stored thereon instructions comprising machine executable code that when executed by at least one machine, causes the at least one machine to:
in response to a determination that resources for a first tenant are to be provisioned,
create a subnet for a virtual private cloud, the subnet not overlapping with any other subnet on a network associated with the virtual private cloud,
create a first VLAN on a gateway communicably coupled to a storage server,
create a first storage virtual machine (SVM) associated with the tenant, and
associate one or more storage volumes of one or more storage devices with the SVM, wherein the one or more storage volumes are not allocated to any other SVM.

9. The non-transitory machine readable medium of claim 8, wherein the machine executable code further comprises machine executable code to configure a first routing table for the gateway, wherein the first routing table routes network traffic to the first SVM through the first VLAN and wherein a second routing table configured on the gateway routes network traffic to a second SVM through a second VLAN on the gateway.

10. The non-transitory machine readable medium of claim 9, wherein the machine executable code further comprises machine executable code to create a first virtual router/forwarder on the gateway in response to determining that resources for the first tenant are to be provisioned and configuring the first virtual router/forwarder to use the first routing table to route network traffic for the first SVM through the first VLAN.

11. The non-transitory machine readable medium of claim 8, wherein the first SVM provides a file system format that is not available on the virtual private cloud.

12. The non-transitory machine readable medium of claim 8, wherein the machine executable code further comprises machine executable code to configure a logical interface on the first SVM, the logical interface mapped to a physical network port of the storage server, the logical interface having characteristics including one or more failover rules.

13. The non-transitory machine readable medium of claim 8, wherein the machine executable code further comprises machine executable code to configure a network connection between the gateway and a virtual gateway of the virtual private cloud.

14. The non-transitory machine readable medium of claim 13, wherein the machine executable code to configure the network connection includes machine executable code to configure the network connection to utilize a Border Gateway Protocol.

15. An apparatus comprising:
at least one processor; and
a non-transitory machine readable medium having stored thereon instructions comprising processor executable code that when executed by the at least one processor, causes the apparatus to,
in response to a determination that resources for a first tenant are to be provisioned,
create a subnet for a virtual private cloud, the subnet not overlapping with any other subnet on a network associated with the virtual private cloud,
create a first VLAN on a gateway communicably coupled to a storage server,
create a first storage virtual machine (SVM) associated with the tenant, and
associate one or more storage volumes of one or more storage devices with the SVM, wherein the one or more storage volumes are not allocated to any other SVM.

16. The apparatus of claim 15, wherein the machine executable code further comprises machine executable code to configure a first routing table for the gateway, wherein the first routing table routes network traffic to the first SVM through the first VLAN and wherein a second routing table configured on the gateway routes network traffic to a second SVM through a second VLAN on the gateway.

17. The apparatus of claim 16, wherein the machine executable code further comprises machine executable code to create a first virtual router/forwarder on the gateway in response to determining that resources for the first tenant are to be provisioned and configuring the first virtual router/forwarder to use the first routing table to route network traffic for the first SVM through the first VLAN.

18. The apparatus of claim 15, wherein the first SVM provides a file system format that is not available on the virtual private cloud.

19. The apparatus of claim 15, wherein the machine executable code further comprises machine executable code to configure a logical interface on the first SVM, the logical interface mapped to a physical network port of the storage server, the logical interface having characteristics including one or more failover rules.

20. The apparatus of claim 15, wherein the machine executable code further comprises machine executable code to configure a network connection between the gateway and a virtual gateway of the virtual private cloud.
